(19) United States
(12) Patent Application Publication
(10) Pub. No.: US 2011/0085685 A1
(43) Pub. Date: Apr. 14, 2011

(54) Sound Amp Ear Device with Ear Phone Jack

(76) Inventor: Victor Kingsun Wai, Hong Kong (HK)

(21) Appl. No.: 12/576,105

(22) Filed: Oct. 8, 2009

(51) Int. Cl. H04R 5/02

(52) U.S. Cl. 381/309

(57) ABSTRACT

A sound amplification system which has a sound application ear device operating a programmable control board. The control board provides a low pitched signal and a high pitch signal. It also provides a mono audio signal and a stereo audio signal and a recharging current. The recharging current charges the rechargeable battery. The rechargeable battery provides power to the device. A microphone is also provided and it transmits exterior sound signals to the programmable control board. An earphone operates with the device and can receive the stereo audio signal. The mono audio signal is amplified and broadcast through a first speaker in the ear device. The stereo audio signal is amplified and broadcast through a second speaker in the earphone.

### BRIEF DESCRIPTION OF THE DRAWINGS

FIG. 1 is a perspective view of the sound amplification ear device on a user;

FIG. 2 is a perspective view of the bottom of the sound amplification ear device;

FIG. 3 is a perspective view of the top of the sound amplification ear device;

FIG. 4 is an exploded perspective view of the sound amplification ear device;

FIG. 5 is an elevational view of the sound amplification ear device;

FIG. 6 is a schematic diagram of the sound amplification ear system;

FIG. 7 is a schematic circuit diagram of the sound amplification ear system;

FIG. 8 is a schematic flow chart diagram of a method of sound amplification.

### DESCRIPTION OF THE PREFERRED EMBODIMENTS

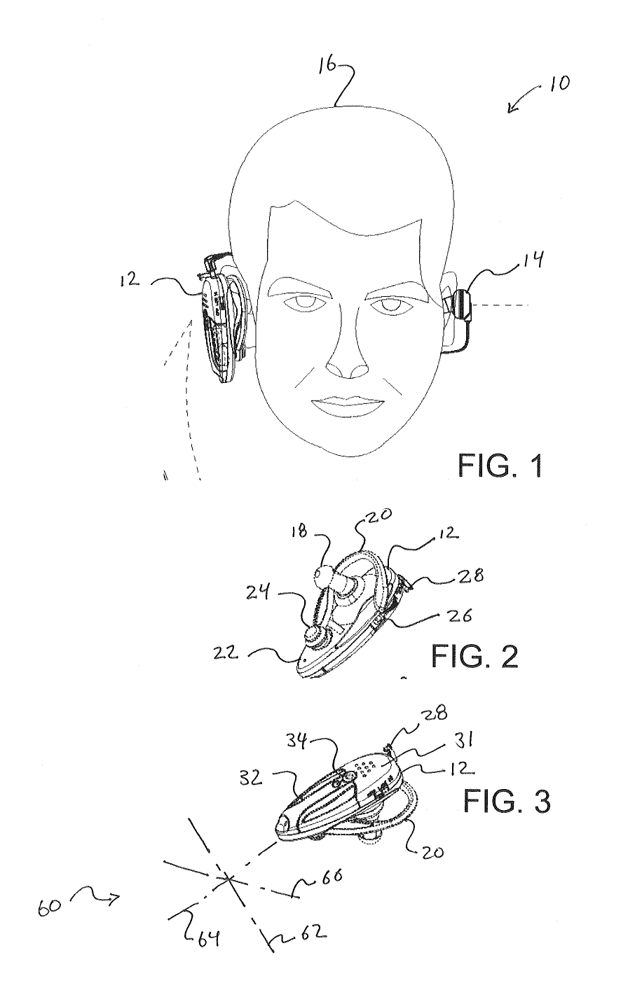

Generally speaking what is provided is a mono/stereo sound amplification ear device 10 as seen in FIG. 1 where a user 16 can position a main sound amplification unit 12 on one ear and connect an earphone 14 via an ear jack to the main sound amplification unit 12 to obtain sound amplification for both ears of the user 16. The sound waves enter through the main sound amplification unit 12 and are processed through a programmable control board where the sound is bisected into a low pitch and a high pitch frequency level and then both low and high pitches are amplified for broadcasting into the user's ears.

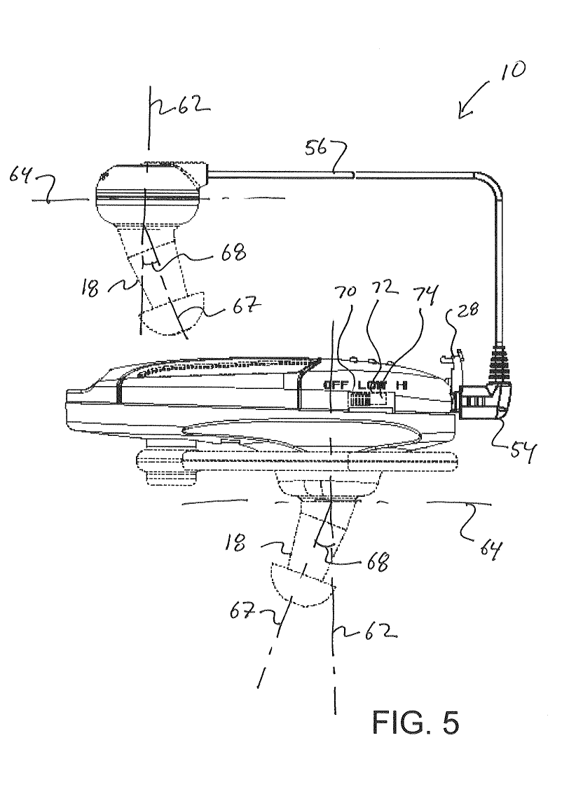

Referring to FIGS. 2 and 3, a detailed discussion of the outer configuration of the main sound amplification unit 12 will now be discussed. In this particular embodiment, an axial system 60 is provided where a vertical axis 62 is defined and a longitudinal axis 64 is perpendicular along the longitudinal length of the main sound amplification unit 12 with a transverse axis 66 acting perpendicularly to the vertical axis 62 and the longitudinal axis 64. In this particular embodiment, the main sound amplification unit 12 has an ear hanger 20 which is connected to a hangar pin 24 extending vertically downward from a lower casing 22. The outer shell of the main sound amplification unit 12 has a lower casing 22 and an upper casing 30. An earpiece 18 extends at an earpiece angle 68 (FIG. 5) along an earpiece axis 67 which is offset at the angular distance 68 from the vertical axis 62. The offset angular distance 68 provides for proper seating of the earpiece 18 into the user's ear during use.

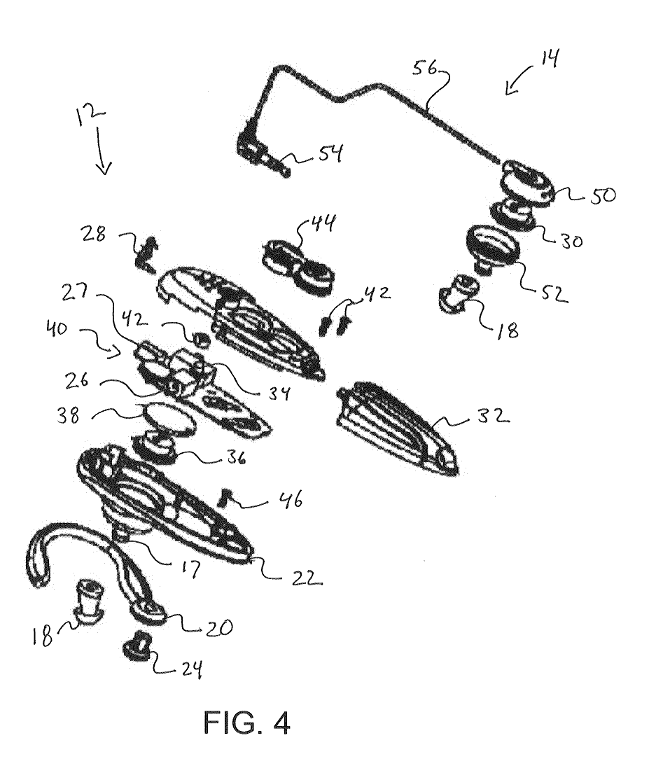

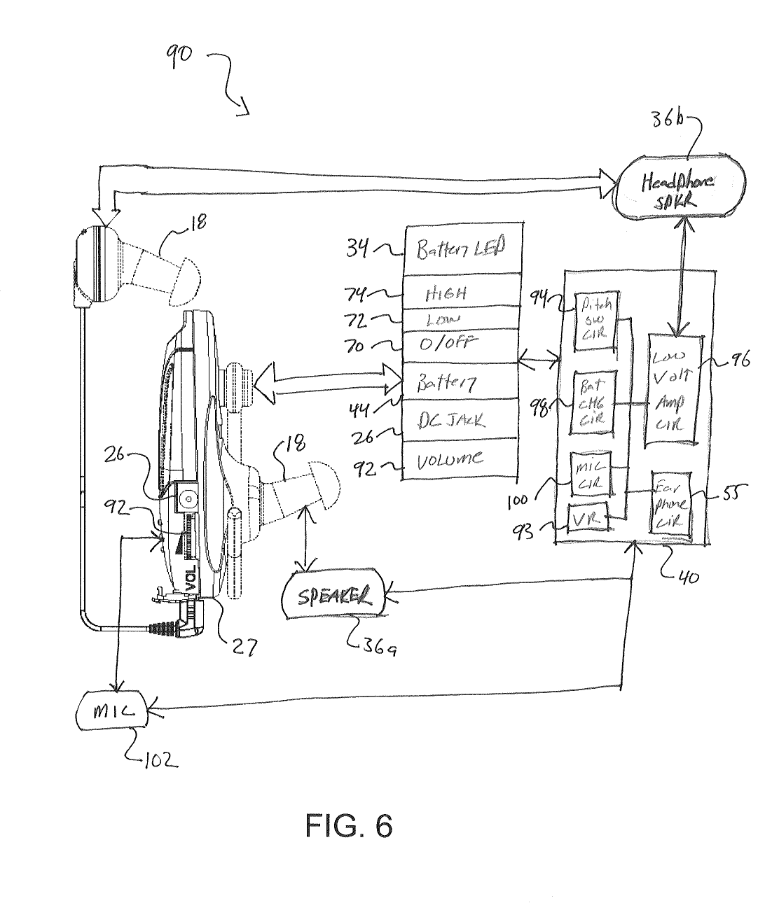

The ear hanger 20 can be configured to wrap around either the user's right ear or the user's left ear. This is accomplished by rotating the ear hanger 20 about the hanger pin 24 and arranging the ear hanger 20 so that it opens towards the opposite transverse direction of the first position. When not in use, a ear phone jack is kept closed by a plug cover 28. The upper case 30 is further divided into two sections, a battery door 32 and a main casing 31 which houses the programmable control board 40 (FIG. 4). An LED power indicator 34 is provided at the upper case to indicate that the unit is on when a green light is shown, and indicate that the battery is charging when the LED turns red. In this particular embodiment, a power adapter (not shown) is provided which is an AC power adapter which plugs into the DC power jack 26 (FIG. 6) on the unit itself. In this particular embodiment, the input voltage is AC 120 V/60 Hz for an (UL version), and AC 230 V/50 Hz for a (GS version) which provides for an output voltage of DC 6 V, 50 milliamps.

Referring to FIG. 4, a discussion of the main components on the interior portion of the main sound amplification unit 12 along with the earphone 14 will now be provided where the sound amplification unit is shown in an exploded format. The earphone 14 will be discussed first. The earpiece 18 for both the earphone 14 and the main sound amplification unit 12 is constructed of a silicone rubber, but other suitable materials are readily conceived. The earpiece 18 fits onto the bottom cover 52 of in this particular situation, the earphone 14. The bottom cover 52 holds the speaker 30 in place and a top cover 50 encases the speaker 30 and operably attaches to the bottom cover 52 to create the earphone speaker unit. An earphone wire 56 is operably attached to the top cover 50 and provides electrical communication to the speaker 30. At the distal end of the earphone wire 56 is an earphone plug 54 which operably connects to the main sound amplification unit 12 through the earphone jack 27 seated on the programmable control board 40.

In order to power the mono/stereo sound amplification ear device 10, a pair of rechargeable batteries 44 are provided. In this particular embodiment, the rechargeable batteries are 1.2 V and are 30H nickel magnesium hydroxide rechargeable batteries. A recharge input voltage of 2.4 volts is required for recharging the battery. The operating current for the programmable control board is 10 milliamps and the speaker impedance for the earphone speaker 30 and the sound application unit speaker 36 is 200 ohms.

A battery door 32 as previously discussed is slidably attachable and removable to the upper case 30 for maintaining the batteries 44 in their stowed position.

Now discussing the programmable control board 40. The main elements on the programmable control board can be seen in this particular exploded embodiment include the LED 34, and the power jack 26 arranged to the transverse side of the programmable control board 40. An earphone jack 27 is extended from the programmable control board towards the aft end of the sound application unit 12. An LED bracket 42 is arranged to hold the LED 34 in place. The sound amplification unit speaker 36 is seated into the lower casing 22 and a speaker cover 38 is seated over the speaker 36 and has a slot for providing electrical communication to the speaker 36. Attached to the bottom portion of the lower casing 22 below the speaker 36 is an earpiece bracket 17 which provides for air medium for transmission of sound waves through the earpiece bracket 17 and the detachable silicon earpiece 18 into the user's ear. The ear hanger 20 is attachable to the lower casing 22 and held in place by the hanger pin 24 which operably detaches from the lower casing 22.

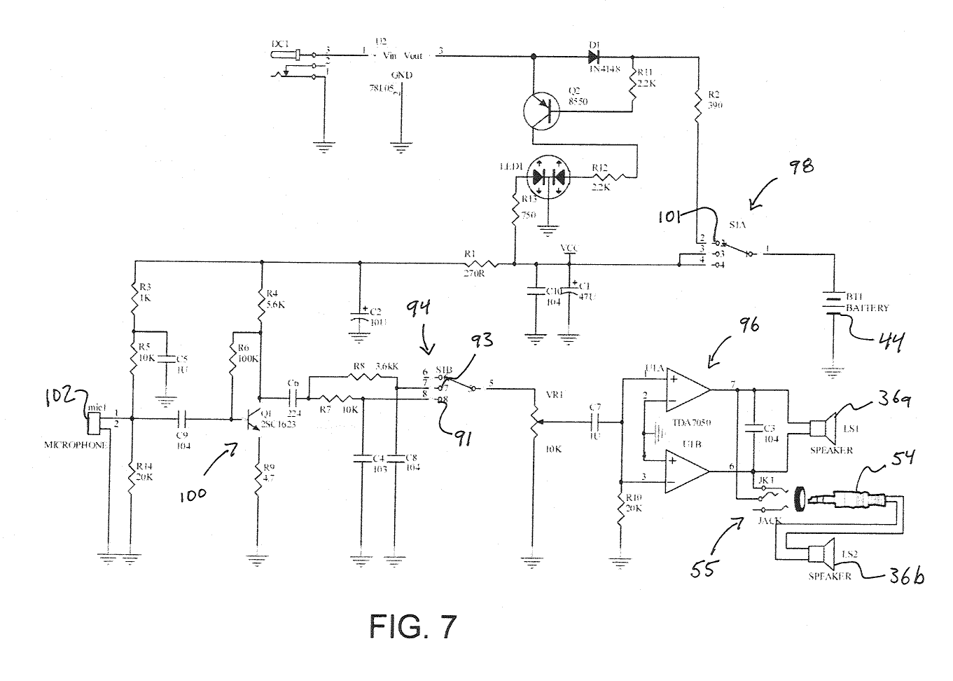

Referring now to FIG. 5, a further discussion of the mono/stereo sound amplification ear device 10 with the earphone 14 plugged into the sound application unit 12 will now be discussed. When the unit is not in use, the switch is turned to the off position 70. During the off position/phase, the rechargeable batteries 44 (FIG. 4) can receive the input voltage of 2.4 V for recharging the batteries. The switch can be put into the low pitch switch position 72 which will provide an amplifier frequency response of between 80 and 3500 Hz for the low setting. In the high pitch switch setting 74, amplifier frequency response is between 80 and 7000 Hz. The batteries at fully charged capacity will provide an operating current for approximately 5 hours continuously. In order to charge the batteries, a three to four hour time period is required. Both the earphone ear piece and the sound amplification unit earpiece are angled along an earpiece axis 67 as previously discussed for proper insertion into the user's ear. This angular distance 68 ranges from between 5° from the vertical axis 62 and 15° from the vertical axis as desired depending upon the design parameters. Referring now to FIGS. 6 & 7, A detailed discussion of the mono/stereo sound amplification ear system 91 will now be provided. What will be discussed is the interoperation between the mechanical actuators (i.e. the switches etc. . . . ), the circuits on the programmable control board 40, and the speakers themselves. The microphone 102 will receive sound from an external sound source and transmit an exterior sound signal to the programmable control board 40. The exterior sound signal is received by a microphone amplification circuit 100 which will amplify the exterior sound signal. The amplified exterior sound signal is provided or is received by a pitch switch circuit 94. This pitch switch circuit 94 has a high pitch signal path 93 and a low pitch signal path 91. The high-pitch and low-pitch signal paths correlate to the high and low amplification frequencies as previously discussed above. To choose either the high-pitched signal path 93 or the low pitched signal path 91, the user can move the switch to a high switch setting 74, a low switch setting 72, or can turn the unit off by moving it to the off switch setting 70. When the switch is in the off/charge position 70, the power adapter when plugged into the power jack 26 can send an input voltage current through a battery charger switch circuit 98 to charge the battery 44. When the switch is in the off charge position 70, and referring to FIG. 7, the battery 44 receives the recharge current from the battery charger switch circuit through the charge path 101 which also corresponds to the off setting 70. After leaving the pitch switch circuit 94, either the high or low pitch signals will be received by the low voltage mono/stereo amplifier circuit 96. This is where the audio signal is split into either a mono sound or a stereo sound.

Either the high-pitched signal or the low pitched signal will be sent to the low-voltage mono/stereo amplification circuit 96 and the circuit will receive the audio signal and transmit a first audio mono signal to the sound amplification unit speaker 36. Concurrently, the low-voltage mono/stereo amplification circuit 96 will also send or transmit a second audio stereo signal to an earphone circuit 55. The earphone circuit 55 will transmit the second audio stereo signal to the earphone jack.

As previously discussed, the earphone plug is configured to interoperate with the earphone jack 27. When the earphone plug 54 is plugged into the earphone jack 27, the earphone plug 54 will receive the second audio stereo signal from the earphone jack 27 and transmit the second audio stereo signal through the earphone wire 56 to the second speaker or the earphone speaker 30. The volume is controlled by a volume control 92 which interoperates with a variable resistor 93 to adjust the volume level of the high-pitched signal or the low-pitched signal.

While the present embodiment circuitry utilizes analog circuitry for the most part, it is readily conceived that a digital programmable logic controller and chip set providing many of the similar operations can be utilized for the control and amplification of the exterior sound signal (i.e. transforming the analog signals from analog to digital using a digital analog signal, processing the digital signals in a digital signal processor, and then converting the processed digital signal through a digital to analog converter for amplification by a mono/stereo amplifier.)

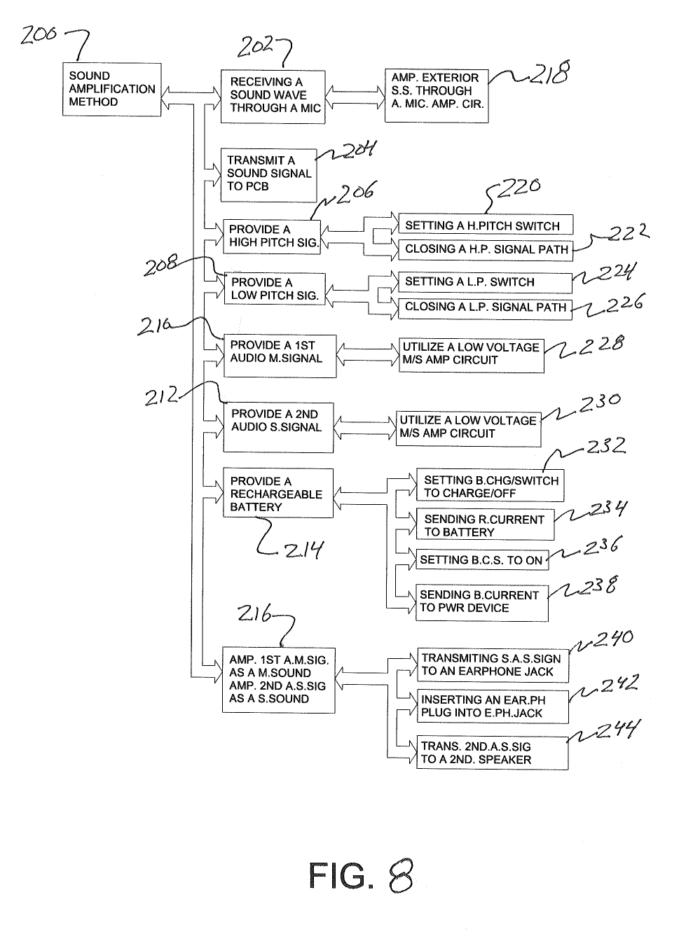

A detailed discussion of the method of sound amplification as seen in FIG. 8 will now be provided. A sound amplification method 200 is provided for application of sound through an ear device. At step 202 the method provides for receiving a sound wave through a microphone where the microphone transmits an exterior sound signal representing the sound wave to a programmable control board at step 204. At step 206, the programmable control board provides a low pitched signal of the exterior sound signal and concurrently, at step 208 the programmable control board provides a high-pitched signal of the exterior sound signal. At step 210, the programmable control board provides a first audio mono signal of either the low-pitched signal or the high-pitched signal. At step 212 the programmable control board provides a second audio stereo signal of either the low-pitched signal or the high-pitched signal.

At step 214, a rechargeable battery is provided for sending and receiving current power for the sound amplification ear device. At step 216, the programmable control board amplifies the first audio mono signal through a first speaker arranged within the ear device which is the sound amplification ear device which provides the mono sound. Also at step 216, the programmable control board amplifies the second audio stereo signal through a second speaker which is arranged within the earphone and provides the stereo sound.

In order to receive the sound wave through the microphone and transmit the exterior sound signal to the rest of the control board, at step 218 a microphone amplification circuit amplifies the exterior sound signal into a high-pitched signal or a low-pitched signal.

Also, in order to provide the low-pitched signal, at step 224, the user can set a low pitch switch and at step 226 close a low pitch signal path which will send the low pitched signal through a pitch switch circuit. Similarly, in order to provide a high pitched signal at step 206, the user can set a high pitch switch at step 220 and close a high-pitched signal path at step 222 which will send the high-pitched signal through a pitch switch circuit.

In order to provide the first audio mono signal at step 210, the circuit utilizes a low-voltage mono/stereo amplifier circuit at step 230 which will receive the high-pitched signal or low-pitched signal and amplify it as a first audio mono signal.

Along the same lines, in order to provide a second audio stereo signal at step 212, the circuit utilizes a low-voltage mono/stereo amplifier circuit at step 230 to receive either the high-pitched signal or the low-pitched signal which is also being received by the mono signal side of the low-voltage mono/stereo amplifier circuit, and amplify the signal as a second audio stereo signal.

In addition to providing a rechargeable battery at step 214, the user is able to set the battery charge/switch to charge/off at step 232. With the unit off, the power adapter can send a recharging current to the battery at step 234. After the battery is charged, the user can set the battery charger switch circuit to on at step 236 and send a battery power current to power the device at 230.

After the second audio stereo signal has been amplified at step 216, the circuit transmits the second audio stereo signal to an earphone jack at step 240. The user can insert an earphone plug into the earphone jack at step 242 and the second audio stereo signal is transmitted to the second speaker at step 244.

1. In combination:
a. a sound amplification ear device comprising a programmable control board;
b. said programmable control board configured to provide a low pitched signal; a high pitched signal; a first audio mono signal; a second audio stereo signal; a recharging current;
c. a rechargeable battery configured to receive said recharging current;
d. a microphone configured to transmit an exterior sound signal to said programmable control board;
e. an earphone configured to interoperate with said sound amplification ear device and receive said second audio signal from said programmable control board;
f. a first speaker arranged within said sound amplification ear device and configured to amplify said first audio signal providing a mono sound;
g. a second speaker arranged within said earphone and configured to amplify said second audio signal providing a stereo sound.

2. The combination according to claim 1 wherein said programmable control board further comprises: a pitch switch circuit comprising a high-pitched setting engaged by a high pitch switch to provide said high pitched signal.

3. The combination according to claim 2 wherein said programmable control board further comprises: said pitch switch circuit further comprising a low pitch setting engaged by a low pitch switch to provide said low pitch signal.

4. The combination according to claim 1 wherein said programmable control board further comprises: a low-voltage mono/stereo amplifier circuit comprising a mono audio setting to provide said first audio mono signal to said first speaker.

5. The combination according to claim 4 wherein said low-voltage mono/stereo amplifier circuit further comprises: a stereo audio setting to provide said second audio stereo signal to said second speaker.

6. The combination according to claim 1 wherein said programmable control board further comprises: a battery charger/switch circuit comprising a charge/off setting, an on setting; said charge/off setting enabling said recharging current to charge said rechargeable battery; said on setting enabling said rechargeable battery to power said sound amplification ear device.

7. The combination according to claim 3 wherein said programmable control board further comprises: a microphone amplification circuit configured to receive said exterior sound signal from said microphone and amplify said exterior sound signal into said high pitched signal or said low pitched signal.

8. The combination according to claim 5 wherein said programmable control board further comprises: an earphone circuit configured to receive said second audio stereo signal from said low-voltage mono/stereo amplifier circuit for transmission of said second audio stereo signal to an earphone jack.

9. The combination according to claim 8 wherein said earphone further comprises: an earphone plug configured to interoperate with said earphone jack and receive said second audio stereo signal; said earphone further comprising an earphone wire configured to transmit said second audio stereo signal to said second speaker.

10. The combination according to claim 3 wherein said programmable control board further comprises: a variable resistor configured to interoperate with a volume control to adjust the high pitched signal or the low pitched signal volume level.

11. (canceled)

12. A method for sound application through an ear device, said method comprising:
a. receiving a sound wave through a microphone, said microphone transmitting an exterior sound signal representing said sound wave to a programmable control board;
b. providing a low pitched signal of said exterior sound signal through said programmable control board;
c. providing a high pitched signal of said exterior sound signal through said programmable control board;
d. providing a first audio mono signal of either said low pitched signal or said high pitched signal through said audio programmable control board;
e. providing a second audio stereo signal of either said low pitched signal or said high pitched signal through said audio programmable control board;
f. providing a rechargeable battery for sending and receiving current to power said sound amplification through said ear device;
g. amplifying said first audio signal through a first speaker arranged within said ear device and providing a mono sound;
h. amplifying said second audio stereo signal through a second speaker arranged within an earphone and providing a stereo sound.

13. The method according to claim 12 wherein said method further comprises: providing said high pitched signal by setting a high-pitched switch to close a high-pitched signal path within a pitch switch circuit.

14. The method according to claim 13 wherein said method further comprises: providing said low pitched signal by setting a low pitched switch to close a low pitched signal path within a pitch switch circuit.

15. The method according to claim 12 wherein said method further comprises: providing said first audio mono signal to said first speaker by utilizing a low-voltage mono/stereo amplifier circuit comprising a mono audio setting to amplify said first audio mono signal.

16. The method according to claim 14 wherein said method further comprises: providing said second audio stereo signal to said second speaker by utilizing said low-voltage mono/stereo amplifier circuit further comprising a stereo audio setting to amplify said second audio stereo signal.

17. The method according to claim 12 wherein said method further comprises: setting a battery charger/switch circuit to a charge/off setting and sending a recharging current to charge said rechargeable battery.

18. The method according to claim 12 wherein said method further comprises: setting a battery charger/switch circuit to an on setting and sending a power current from said rechargeable battery to power said sound amplification in said ear device.

19. The method according to claim 14 wherein said method further comprises: receiving said exterior sound signal from said microphone and amplifying said exterior sound signal into said high pitched signal or said low pitched signal through a microphone amplification circuit.

20. The method according to claim 16 wherein said method further comprises: receiving said second audio stereo signal from said low-voltage mono/stereo amplifier circuit and transmitting said second audio stereo signal through an earphone circuit to an earphone jack.

21. The method according to claim 20 wherein said method further comprises: inserting an earphone plug into said the earphone jack and receiving said second audio stereo signal.

22. The method according to claim 21 wherein said method further comprises: transmitting said second audio stereo signal along an earphone wire to said second speaker to provide said stereo sound.

23. The method according to claim 14 wherein said method further comprises: adjusting said high pitched signal or said low pitched signal volume level by utilizing a volume control interoperating with a variable resistor.

24. A sound application system comprising:
a. means for receiving a sound wave
b. means for transmitting an exterior sound signal representing said sound wave to a programmable control board;
c. means for providing a low pitched signal of said exterior sound signal through said programmable control board;
d. means for providing a high pitched signal of said exterior sound signal through said programmable control board;
e. means for providing a first audio mono signal of either said low pitched signal or said high pitched signal through said audio programmable control board;
f. means for providing a second audio stereo signal of either said low pitched signal or said high pitched signal through said audio programmable control board;
g. means for providing a rechargeable battery for sending and receiving current to power said sound amplification through said ear device;
h. means for amplifying said first audio signal through a first speaker arranged within said ear device and providing a mono sound;
i. means for amplifying said second audio stereo signal through a second speaker arranged within an earphone and providing a stereo sound.
